(19) United States
(12) Patent Application Publication
(10) Pub. No.: US 2005/0130541 A1
(43) Pub. Date: Jun. 16, 2005

(54) Gypsum board having one nonwoven liner and improved toughness

(76) Inventor: Ashok Harakhlal Shah, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/737,561

(22) Filed: Dec. 16, 2003

(51) Int. Cl. D04H 1/00; D04H 3/00; D04H 5/00; D04H 13/00; B32B 5/26; B32B 13/02; B32B 13/14; B32B 27/12

(52) U.S. Cl. 442/386; 442/381; 442/394; 442/361

(57) ABSTRACT

The present invention relates to a gypsum board having a nonwoven liner and a gypsum core. The gypsum board of the present invention has a high work to break, resulting in a gypsum board product that has a high resistance to abuse in use. The gypsum board of the invention is also more flexible and more resistant to water and fire than paper-lined gypsum board, and does not contain nutrients that support mold growth.

### BACKGROUND OF THE INVENTION

1. Field of the Invention

The present invention relates to an improved gypsum-based substrate faced with a polymeric nonwoven sheet material on one side thereof, the gypsum-based substrate suited for use in construction materials such as wall panels, ceiling panels, floor underlayment and interior and exterior sheathing.

2. Description of the Related Art

Gypsum board is traditionally manufactured by a continuous process. In the process, a gypsum slurry is first generated in a mechanical mixer by mixing calcium sulfate hemihydrate (also known as calcined gypsum), water, and other agents. These various additives are used in the gypsum slurry as set accelerators (such as ground gypsum, potassium sulphate), set retarders (such as diethylene triamine tetra acetic acid), water reducing agents (such as condensed naphthalene sulphonates), foaming agents (such as lauryl alcohol ether sulphates), liner bonding agents (such as starch), anti-burning agents (such as boric acid), glass fibers for improved physical properties and fire resistance, other agents to improve reaction to fire properties (such as clay), water proofing agents (such as wax or silicones), or other agents. The gypsum slurry is deposited on a paper sheet which has had each edge scored or creased to facilitate the folding of the edges to make a sidewall of height equal to board thickness and a further flap of width about 1 inch wide folded back over the board. An upper continuously advancing paper sheet is then laid over the gypsum slurry and the edges of the upper and lower sheets are pasted to each other using glue at the edges of the top and/or bottom sheet. The paper sheets and gypsum slurry are passed between parallel upper and lower forming plates or rolls in order to generate an integrated and continuous flat strip of unset gypsum sandwiched between the paper sheets that are known as facing or liners.

Gypsum board has been the subject of numerous patents, such as U.S. Pat. No. 4,057,443, Canadian Patent No. 1,189,434, as well as co-pending U.S. patent application Ser. Nos. 09/512,921, 09/513,097 and 10/172,135, assigned to DuPont, all of which are incorporated herein by reference.

For years it has been recognized that high toughness and abuse resistance are desirable properties in gypsum-based board for use in buildings. High toughness and abuse resistance are here characterized in terms of high initial modulus, high flexural strength corresponding to high-to-moderate initial modulus, high maximum flexural strength and high work-to-break. In addition to high toughness, it is desirable for gypsum board to have abrasion and indentation resistance in order to resist abuse and to provide some flexibility under load.

Standard gypsum boards are produced with a cellulosic paper liner that provides reasonable strength and a paintable surface to the finished gypsum board. However, there are several disadvantages to the use of paper as a liner for gypsum board. Paper acts as a food source for mold and mildew. Also paper becomes especially weak and subject to delamination either directly from the gypsum core or between the layers of the multi-layer sheets when the paper becomes damp due to water leaks or high humidity. Also, it has been a notorious problem with the standard paper-lined gypsum board that the paper liner peels off while removing wallpaper. The most common technique for removing the old wall paper is to perforate the old wall paper by scoring and then wetting the perforated wall paper with water to loosen up the glue underneath the wall paper, which results in moist paper liner and hence, the paper liner becomes very susceptible to peeling when the wall paper is removed.

In addition, standard paper-lined gypsum board has lower work-to-break and abrasion resistance than is needed for certain applications. On a stress-strain curve, WTB is represented by the area under this stress-strain or breaking curve. In use, paper-faced gypsum boards are generally coated with another material, such as specialty paint or wall coverings, in order to achieve high abrasion resistance. For greater durability, paper-faced board is frequently covered with a wallpaper of hard sheet or plastic film when used in high traffic areas.

Commercially available gypsum board products with liners other than cellulosic paper have been developed, an example being Dens-Armor™ Plus interior wallboard (available from Georgia-Pacific, Inc., Atlanta, Ga.). Dens-Armor™ Plus uses a glass mat in place of cellulosic paper liner. However, this product has relatively low WTB and low deflection and hence, is brittle. In addition, the surface of the Dens-Armor™ Plus is very different from standard cellulosic paper-lined gypsum board for interior use—for example, it does not accept paint as well. For use in interior walls, it is desired to have a gypsum board with a surface similar to standard paper-lined gypsum board so that it can be painted and have a similar appearance as standard paper-lined board.

Canadian Patent No. 1,189,434 to describes a stronger and more durable synthetic sheet materials as a substitute for the paper liners found in conventional gypsum board products. The patent discloses gypsum panels made with a facing of Tyvek® sheets made by solution flash-spinning polyethylene to form fine plexifilamentary fibril structures that can be thermally bonded to form a moisture vapor permeable spunbonded nonwoven material. Tyvek® is a registered trademark of E.I. du Pont de Nemours and Company of Wilmington, Del. (DuPont). However, the gypsum board product made according to the patent has several shortcomings. The product has been found to have poor adhesive bonding between the liner material and the gypsum slurry during the board manufacturing process. In addition, although the Tyvek liner is as strong as paper in the machine direction (MD) and almost three times as strong in the cross direction (CD), the board strength is only about one-third that of paper-lined standard gypsum board in the MD of the liner. In addition, the surface of the gypsum board is shiny and almost film-like smooth, which are characteristics of the Tyvek® sheet surface and which is not a desirable surface for gypsum board. Also, the melting point of Tyvek® sheet is quite low at 135° C., and the sheet starts shrinking at temperatures close to 100° C. This is a disadvantage because the drying ovens used in conventional gypsum board-making processes operate at temperatures well above 100° C., usually above 150° C.

It is desired to have gypsum board which would not sag or significantly lose its flexural strength when wet or in a high humidity environment. In addition, it is also desired to have abrasion and indentation resistant gypsum board. It is also desired to have gypsum board with high peel strength between the liner and the core. It would also be desirable to have good release properties between the liner and an overlying covering.

It is also desired to have a gypsum board substantially free of ingredients that would act as nutrients for mold growth. Conventional gypsum board contains organic matter, which provides food for fungi such as mold and mildew.

### BRIEF SUMMARY OF THE INVENTION

In one embodiment, the present invention relates to a gypsum board comprising a gypsum core held between two sheets of liner wherein one sheet is a face liner for covering the exposed side of the gypsum board and the other sheet is a back liner for covering the non-exposed side of the gypsum board wherein one of the liners is a polymeric nonwoven sheet material, and wherein the work-to-break of the gypsum board in the MD of the polymeric nonwoven sheet material at a strain of 0.75 inch is greater than 30 lb-in when the work-to-break test is conducted with the center load applied to the board on the side opposite the polymeric nonwoven sheet material.

In another embodiment, the invention relates to a gypsum core held between two sheets of liner wherein one sheet is a face liner for covering the exposed side of the gypsum board and the other sheet is a back liner for covering the non-exposed side of the gypsum board wherein one of the liners is a polymeric nonwoven sheet material, and wherein the work-to-break of the board in the MD at a strain of 0.75 inch is greater than 60*X lb.-in. where X is the thickness of the board in inches, when the work-to-break test is conducted with the center load applied to the board on the side opposite the polymeric nonwoven sheet material.

### BRIEF DESCRIPTION OF THE DRAWINGS

FIG. 1 presents stress-strain curves illustrating the deformation of various gypsum board samples (measured in distance units) as an increasing level of force is applied (measured in force units).

### DETAILED DESCRIPTION OF THE INVENTION

This invention describes a gypsum board product that is made by using a liner of a polymeric nonwoven sheet material lining one side of the board. For indoor applications, the side of the gypsum board that is exposed and visible is commonly known as the “face” side. The other side (also referred to as the “opposite side”) of the gypsum board is commonly known as the “back” side. This “back” side is the side that is in contact with the studs and the cavity behind the wall (also referred to as the “wall cavity”).

While in general it is desirable to have the nonwoven liner on both the face and the back sides of the gypsum board for good impact resistance as described in pending U.S. patent application Ser. No. 10/172,135, nonwoven liners are more expensive than conventional cellulosic paper liner. It has been found that the gypsum board of the present invention, having a nonwoven liner on only one side thereof, is equally acceptable in use in some applications and is generally more affordable. The opposite side of the board is lined with some other substrate such as glass, paper, etc., as described herein.

The nonwoven sheet may line either the face side or the back side of the gypsum board, resulting in different product properties, as discussed further herein. Depending on the particular embodiment, the board product has unique and improved properties when compared to the conventional boards currently available: high work to break (WTB); good initial modulus, yield strength and peak load; and good resistance to abuse through abrasion and indentation, either before or after decoration of the surface, as compared to standard paper-lined board.

It is an object of the present invention to provide a gypsum board that provides the following product attributes: flexibility, high toughness, mold resistance, resistance to indentation, paper-like surface and affordability.

It would be desirable to provide a gypsum board that provides the following attributes: high surface stability against abrasion and peeling, resistance to liquid water and high humidity and fire resistance.

The product can also be manufactured in such a way that the product will not support mold growth and allows the construction of mold resistant structures.

Due to the generally hydrophobic nature of the polymeric liners, the board can also be manufactured in such a way that the board is much more resistant to the deleterious effects of liquid water or water vapor when compared to conventional paper-lined gypsum boards. The board can also be manufactured in such a way that the board has improved fire resistance and reaction to fire properties.

This invention also describes the process by which this product is made, including the use of a dense layer of gypsum next to the liner surface to promote good wet bonding and the use of additives that will promote good bonding of the liner to the gypsum core. The invention can be implemented using a conventional gypsum board machine to make a wide range of superior products, with only minor changes to the equipment as required to accommodate the high performance properties of the nonwoven liner and board.

In a first embodiment, the present invention is directed to a gypsum board product lined on one side with a nonwoven fabric wherein the board has high WTB in the machine direction (MD) of the nonwoven fabric when the WTB test is conducted with the center load applied to the liner on the side opposite the side lined with the nonwoven fabric, in addition to good initial modulus, yield strength and peak load. Hereafter, unless noted otherwise, the WTB will be conducted with the center load applied to the liner on the side opposite the side lined with the nonwoven fabric. It should also be noted that by “machine direction” (MD) is meant the direction in which the nonwoven liner is produced (parallel to the direction of travel through the sheet-forming machine), and by “cross direction” (CD) is meant the direction perpendicular to the machine direction. It should be further noted that the MD and CD of the nonwoven liner will likewise determine the MD and the CD of the gypsum board. The gypsum board products of the present invention exhibit WTB in the MD of the nonwoven liners of greater than 30 lb.-in. at a strain of 0.75 in., and preferably greater than 40 lb.-in. at a strain of 1.0 in., even when the board has a thickness of only about 0.5 in. More preferably, the WTB in the MD of the gypsum board products of the present invention can be expressed by the equation:
WTB≧60*×X lb-in
wherein X is the thickness of the board in inches.

The WTB of the gypsum boards of the present invention in the CD of the nonwoven liners is greater than 10 lb.-in. at a strain of 0.75 in., preferably greater than 10 lb.-in. at a strain of 1.0 in.

The initial modulus of the inventive gypsum boards in the MD is at least 500 lb./in., with a peak load of at least 40 lb. The WTB at peak load is at least 30 lb.-in.

The gypsum boards of the present invention preferably will not break even when subjected to a bending strain of 0.5 in. at a bending stress of greater than 40 lb., or even at 1.0 in. strain and 45 lb. stress. When the flexural strength peak load is measured immediately after holding the gypsum board of the present invention under water for 2 hours per ASTM C36, it would be expected that the gypsum boards only show a loss of less than 75% in MD flexural strength. The gypsum board of the present invention has a ratio of the flexural strength peak load in the MD to the peak load in the CD less than 3.

The gypsum board of the invention includes two sheets of liner which envelope a gypsum core. One of the liners is a porous, fibrous, polymeric nonwoven sheet which can be comprised of thermally and/or chemically bonded meltspun substantially continuous fibers, carded and/or air laid staple fibers webs, needle punched staple fiber webs, hydroentangled fibrous webs or other nonwoven structure. The nonwoven liner is made from fiber forming polymers derived from condensation- and/or addition-type monomers. Such polymers include polyethylene, polypropylene, aliphatic or aromatic polyamides or poly(ethylene terephthalate) (PET). Preferably, the nonwoven liner comprises a polymer having a softening or melting point of greater than 150° C. Such polymers include polypropylene, which has a softening or melting point of 160° C. and PET, which has a softening or melting point of 250° C. The reason for this is that the drying oven temperature is much higher than 100° C., and usually above 150° C. A liner made from a sheet having a softening or melting point lower than 150° C. can melt, buckle or shrink during the drying step of the process.

The fibers that form the nonwoven liner for use in the present invention can contain additives such as dyes, pigments, UV and thermal stabilizers and antimicrobial agents.

Preferably, the nonwoven liner is a mixture of monocomponent fibers and bicomponent fibers that have been carded and/or air laid and hydroentangled into a nonwoven sheet and then bonded during drying and hot calendering. When sheath-core type bicomponent fibers are used in the nonwoven liner, the melting point of the sheath is sufficiently lower than that of the strength contributing fiber core and any monocomponent fibers to thermally bond the entire sheet structure. It is possible that the fibers providing thermal bonding can be low melting monocomponent fibers, although bicomponent fibers are preferred. When the nonwoven liner comprises a mixture of monocomponent and bicomponent fibers, the amount of bicomponent fibers is between about 10 wt. % and 50 wt. % of the weight of the liner fabric, preferably between about 15 wt. % and 35 wt. %.

Additionally, the nonwoven liner used in the invention should have the right level and right type of strength properties in order to produce novel gypsum board with specific strength properties. The nonwoven liner preferably has a strip tensile strength in the MD and CD similar to paper. In addition, the nonwoven liner according to the present invention should have a low-to-moderate percent elongation-to-break under load.

The tensile strength of the nonwoven liner contributes to the improved properties of the board of the present invention. The strip tensile strength is at least 35 lb./in., preferably above 65 lb./in., in the MD and at least 12 lb./in., preferably above 22 lb./in in the CD. The elongation-to-break, that is the percentage of deformation at the breaking point, of the nonwoven liner is at least less than 100%, preferably less than 50% in the MD and at least less than 300%, preferably less than 100% in the CD. The percent elongation of the liner at 1 lb. of force is at least less than 0.7%, preferably less than 0.5% in the MD and at least less than 3%, preferably less than 1.5% in the CD. The percent elongation of the liner at 3 lb. of force is at least less than 1.5%, preferably less than 0.7%, in the MD and at least less than 7.0%, preferably less than 3.0%, in the CD.

The nonwoven sheet of the liner has a stiffness that is high enough to allow the sheet to be folded and scored, like paper, for ease of replacing paper on existing gypsum board manufacturing machines. This is especially desired when the nonwoven sheet is used as the bottom liner on which the gypsum slurry is first deposited during the board forming process.

The liner on the opposite side of the gypsum core from the nonwoven sheet may be any of several types of sheet material. It may be paper of cellulosic fibers such as is used in standard paper-lined wallboard, a fabric of glass fibers (continuous or discontinuous), a film, a woven fabric, a scrim, or some combination thereof.

For some applications in which good impact resistance is desired, the gypsum board of the invention is lined with a nonwoven liner on the back side of the board. This board is suitable for use in residential or commercial construction.

For applications in which improved mold resistance is desired, the gypsum board of the invention comprises a core substantially free of nutrients capable of supporting microbial growth. By “microbial” is meant any organism of microscopic or ultramicroscopic size, including fungus, mildew, and bacteria. For applications in which mold resistance is desired on the back side of the board, i.e., the side in contact with the wall cavity in which high humidity and moisture condensation may be present in use, the gypsum board of the invention includes a nonwoven liner that is free of nutrients capable of supporting microbial growth. For further mold resistance, the gypsum board itself may be substantially free of nutrients capable of supporting microbial growth, in which case, each component of the board, the liners, adhesives and the gypsum core, are each substantially free of nutrients capable of supporting microbial growth.

In embodiments of the invention in which the board is lined with a nonwoven liner on the back side of the board, instead of the face side (to provide impact resistance, for example), the board may include a heavy cellulosic paper, such as that conventionally used to line gypsum board, on the face side of the board in order to provide surface indentation resistance and ease of finishing or painting. The paper used may optionally be specially formulated for reduced nutrient content for microbial growth and/or may be treated with biocides for resistance to microbial growth.

In another embodiment of the invention, a nonwoven liner is used on the face side of the gypsum board. The back side of the board may be lined with a less expensive liner, such as a liner of glass fibers or film etc. The glass liner may be woven or nonwoven, and the glass fibers may be continuous or discontinuous. Since the nonwoven liner has a surface similar to conventional cellulosic paper, a desired surface finish is attainable by conventional finishing steps such as covering the joints and fastener heads with joint compound in accordance with ASTM C 840 section 22.6 Level 3 or 4 before priming and painting. This would be advantageous because the expensive application of joint compound (also known as “plaster compound,” or “mud”) over its entire surface could be avoided. It should be noted that because most of the commercially available joint compounds are formulated for the conventional cellulosic paper, minor adjustment in the joint compound formulation may be helpful due to small difference in the surface texture of nonwoven liner as compared to standard cellulosic paper. Using the gypsum board of the invention, it is only necessary to apply joint compound at the joints between wallboard and over nail holes. In contrast, DensArmor™ Plus from GP Gypsum (subsidiary of Georgia Pacific Corp., Atlanta, Ga.) requires ASTM C 840 section 22.6 Level 5 preparation, i.e., application of joint compound over the entire surface, in order to achieve an uniform surface finish, that is, where joints or nail heads are not visible. It is desired that the surface of the nonwoven liner have good surface wettability to impart good paintability.

In this embodiment of the invention, the strength characteristics of the nonwoven liner affect the indentation resistance of the board, and the hardness and compressive strength of the gypsum core beneath the face liner also contribute to the indentation resistance. In addition, the use of a nonwoven liner on the face side helps to improve the indentation resistance of the face side of the board.

Further, this embodiment of the invention may be made to be highly resistant to mold by reducing the nutrient content of the core formulation and/or including biocides in the core. It would also be desirable for the joint compound mentioned above as well as any joint tape to be substantially free of nutrients that would support mold growth and the like. The joint tape is preferably made from the same nonwoven materials as used for the board liner.

Both of the liners enveloping the gypsum core should have sufficient porosity and bulk (defined herein as the thickness per unit basis weight·density) to allow some penetration of the wet gypsum slurry through the liners during board formation while still containing the gypsum slurry therebetween. A liner structure having very densely packed fibers will have very poor wet adhesion to the gypsum slurry, while liners that are too bulky and open can not have the desired strength per unit basis weight and can allow complete seepage of the wet gypsum slurry.

The nonwoven liner used in the present invention is a porous sheet material in which the mean flow pore diameter is in the 5 to 100 micrometer range, preferably 7-70 micrometers. The mean flow pore pressure is at least less than 3 psi, preferably less than 1 psi. The nonwoven liner has a specific level of body, that is, it comprises at least 20% voids by volume, preferably greater than 50% and its bulk is at least 1.25, preferably greater than 2.

According to one preferred embodiment of the invention, the nonwoven liner has a first surface characterized by pores or spaces formed between the fibers of the liners, which pores are of sufficient size for a gypsum slurry to enter the pores and become intertwined with the fibers so as to form a strong mechanical bond between the gypsum core and the liners when the gypsum sets up. The above-described combination of pore size, voids and bulk range allow the wet, set gypsum layer to intertwine with the fibers of the nonwoven liner, providing good wet adhesion, without the gypsum slurry penetrating completely through the nonwoven liner to the other side.

The nonwoven liner for use in the gypsum board of the invention must have good wet adhesion with the gypsum core. The wet adhesion between the liner and the core is partly determined by the structure and composition of the sheet used as the liner material and partly by the composition of the gypsum core. The wet adhesion is particularly important for the production of the board because as a routine part of the conventional process for making board, the assembly of the liners and gypsum core is flipped. Good wet adhesion is critical to keep the assembly intact during this step of the board production process.

It is also important to have good dry adhesion between the nonwoven liner and the gypsum core for translating liner strength to the finished gypsum board strength properties. In addition to mechanical interaction due to slurry penetration inside the liner structure, it is believed that chemical bonding between the liner and gypsum core also helps in improving the dry adhesion.

It is desired that the fibers at the surface of the nonwoven liner coming in contact with the wet gypsum slurry be chosen to have sufficient micro-movement to allow for the swelling and then shrinking of the gypsum core that occurs during the setting and drying steps.

Depending on the application of the gypsum board product, different product properties may be desired, and therefore, different product configurations may be employed. For instance, when the surface of the board product exposed to the interior of a room in an indoor application will likely be exposed to abuse, it is desired for the board to have high surface indentation and abrasion resistance while at the same time have a smoothness similar to paper based gypsum board. This may be achieved by lining the face side of the gypsum board with a nonwoven liner in which the liner surface exposed to the interior of the room has a smoothness similar to paper. The liner surface exposed to the gypsum core may be preferentially rougher for improving wet and dry adhesion.

When the gypsum board of the invention is intended for interior use, it is preferable for the appearance of the exposed surface of the liners, i.e. the “outside surface,” to be as similar as possible to that of paper liners commonly used in gypsum board. It is preferable for the nonwoven liner of the present invention to resemble the surface of common paper liners in order to provide a suitable appearance upon painting of the outer surface. Likewise, the outer surface of the nonwoven liner should be as similar as possible to common paper liners in order to facilitate application and removal of wallpaper.

In order to impart to the nonwoven liner a similar degree of smoothness (or roughness) as that of paper, the nonwoven liners can be hot calendered. Hot calendering also improves liner strength properties that result in improved gypsum board strength properties; specifically gypsum board modulus, yield strength and peak load with high WTB. In addition to, or instead of, hot calendering, thermal bonding can be achieved by various other techniques, such as, through-air bonding, infrared bonding and thermal bonding in a hot air convection oven. A binder fiber can also be used, comprising a low melting monocomponent and/or bicomponent fibers. The process can be combined with a chemical bonding process, such as resin bonding where the binder component (with crosslinking agents if needed) is applied to the liner bulk by various techniques, such as spray, foam, etc., followed by drying and/or curing steps. The binder can be in powder form and can be applied in dry form simply by spraying.

Preferably, the fibrous nonwoven sheet material for use in the invention has some fibers protruding from its surface on a microscopic level on at least one side thereof, which when the gypsum board is produced is the side in contact with the gypsum core. This can be accomplished by subjecting the fibrous nonwoven sheet to treatments such as hydroentangling, air jet entangling and needlepunching. Since a rough surface will enhance the interaction between the liner surface and gypsum in the wet and dry stages, it can be helpful to have the liner surface coming in contact with the gypsum slurry, i.e. the “inside surface,” be rough.

It is also possible to bond the nonwoven liner to another sheet material combining the improved properties of the nonwoven liner with the additional properties of the added bonded layer. Examples of materials that could be used as multi-layers in this manner are other nonwoven liners, woven sheet, scrim, film, foil, etc. As discussed above, breathability of the liner is needed for drying of the gypsum core. It is possible that the breathability of the liner can be discrete (areas of liner with high, low or zero breathability). In addition, it is also possible that one side of the gypsum board can have low or no breathability.

It is to be noted that a fine embossed pattern on the liner surface does help in wet adhesion; however, the embossed pattern will create a surface other than a smooth paper-like surface. When the gypsum board is to be used in exterior applications, it can be desired to include in the board a nonwoven liner that has been embossed with a pattern of channels large enough for water to drain under gravitational force.

The gypsum core is formulated to work with the properties of the nonwoven liner to provide the improved gypsum board of the invention. The nature of the chemical composition of the core has been found to enhance the dry bond strength between the core and the liners.

The major ingredients in the gypsum slurry formulation of the present invention are stucco (hemihydrate CaSO₄), accelerator like finely ground gypsum (CaSO₄.2H₂O) and K₂SO₄, foaming agent added as a premixed foam, and a binder, preferably a non-starch-based binder, for example polyvinyl alcohol (PVA) or latex. The latex, of course, would be of the type that does not provide a food source for mold and other fungi. It is preferred that the non-starch-based binder used is insoluble in water at room temperature and provides high dry bond strength between the liner and the core upon drying. Other non-starch-based binders, such as polyvinyl acetate can also be used. The formulation can also contain cross-linking agents for making the binder completely insoluble in water upon drying. The PVA is added as a solution to the core, but can be added in other ways, such as by adding a powdered PVA that dissolves during the setting and drying steps, or by spraying solution directly on the liner surface. Other additives, such as water reducing agents or anti-burning agents, often found in regular gypsum board can also be added as required to adjust the core formulation to the manufacturing process.

Wetting agents can also be used in the slurry or applied directly onto the liner surface to enhance wetting and penetration of the gypsum slurry between the individual fibers as much as possible. These wetting agents can include synthetic chemicals with hydrophilic and hydrophobic groups that are known to reduce surface tension of aqueous solutions and reduce contact angles with hydrophobic solids. A wide range of wetting agents will perform this function such as soaps and detergents, or foaming agents. A preferred wetting agent is polyvinyl alcohol (PVA).

It is also possible to add other ingredients to the slurry to improve the product performance or to optimize the process of manufacture. Examples of such ingredients are glass fibers and/or clay to improve fire resistance, boric acid to prevent calcination during drying, etc. If one of the requirements for the product is mold resistance, then additives such as dextrose, glue or starch that provide a food source for mold and other fungi should not be used.

In a preferred embodiment of the invention for applications, such as for outdoor walls or indoor residential bathroom walls, the core contains a water-proofing agent, e.g., wax or silicone, in order to impart water resistance to the gypsum board. In yet another preferred embodiment for some applications, the core contains both waterproofing agents and agents to improve fire resistance, such as glass fibers or clay.

Preferably, the board of the invention has a thin higher density layer of gypsum with reduced air void percentage immediately underneath the liner to achieve the desired edge and surface hardness of the finished gypsum board. This can be achieved by a process known as “roller coating,” described in U.S. Pat. No. 1,953,589 and U.S. Pat. No. 5,718,797, both of which are incorporated herein by reference. In roller coating, gypsum slurry of higher density is first laid on the bottom liner and then the gypsum slurry of normal or lighter density is poured on top. The top liner is also coated with a thin layer of gypsum slurry of higher density. The result is a thin layer of gypsum of higher density immediately under the outside liners and along each edge so that the board has improved properties such as increased hardness.

One of the major benefits of the gypsum board products of this invention is that the novel board can be made on an existing board manufacturing line with only modest changes to the process formulation and equipment. The changes to the process formulation and equipment are the result of optimizing the product and process to take best advantage of the improved gypsum board liner and gypsum board product, as well as required changes to accommodate the much improved physical properties of the final gypsum board product.

### Test Methods

### Measuring the Characteristics of the Nonwoven Liner:

The strip tensile properties of the liners were measured according to ASTM 5035 using a CRE (constant rate of extension) Instron Tensile Tester (available from Instron Corporation of Canton, Mass.). The sample size used was 1 inch by 8 inch; the gauge length was 5 inches, and the speed was 2 inches per minute. The properties measured were peak load (lb.), elongation-at-break (%), elongation at 1 lb. load (%) and elongation at 3 lb. load (%).

The pore data for the liners were obtained on a PMI machine with a top to bottom flow chamber (manufactured by Porous Materials, Inc. of Ithaca, N.Y.). A sample holder with a 2.5 cm diameter was used, with a 40 mesh supporting screen (wire diameter of 0.25 mm and screen opening of 0.375 mm) below the sample. The test fluid used was Silwick-20.1 dynes (available from PMI). The sample was prepared in the test fluid under a vacuum level of 23 mm Hg for 1 minute. Mean flow pore diameter (micrometers) and mean flow pore pressure (psi) were measured and reported.

Bulk (unitless) was calculated according to the following formula: Thickness (mils)/basis weight (oz/yd²)×density (g/cm³)×0.7493. The density of PET was assumed herein to be 1.38 g/cm³; the density of the copoly(ethylene terephthalate) was assumed herein to be 1.35 g/cm³; the density of linear low density polyethylene (LLDPE) was assumed herein to be between 0.91 to 0.95 g/cm³; and the density of nylon 6,6 was assumed to be 1.3 g/cm³.

Basis Weight (weight per unit area, oz/yd²) was calculated by ASTM D3776.

Percent void (%) was calculated according to the following formula: (1−1/Bulk)×100.

Method for Preparing the Gypsum Board for Measuring the Breaking Characteristics:

Gypsum board using a specific gypsum slurry formulation and specific liner was prepared as described below. There were two types of board making procedures used: (1) roller coating the bottom liner, and (2) board made without roller coating the bottom liner. In both cases two pieces of liner, 14 inches long and 10 inches wide, were secured in a mold at one end, the two pieces being held apart by a 0.5 inch thick spacer. The mold was made such that the open end of the mold was 1 inch higher than the closed end of the mold, this helping to keep the slurry from running out the open end of the mold. The top of the mold was open initially allowing the top liner to be folded in place once the slurry was poured on the bottom liner. The edges were of 0.5 inch high such that when the slurry was poured on the bottom liner, the slurry spread and the top liner put in place, a sample 10 inches wide, about 12 inches long and 0.5 inch thick was prepared. The procedure for board-making for each type is as follows:

If the bottom liner was to be roller-coated, the stucco/accelerator blend was sifted into water in a Cuisinart Model CB-4J blender (made by Cuisinart, E. Windsor, N.J.) over 30 seconds, and the mixture was mixed on high speed for 7 seconds. At this point, 50-75 ml of the mixture was quickly poured along one end of the mold on the back face of the bottom liner and a 10 in. wide trowel was used to spread the mix over the surface of the liner. Four passes of the trowel were made, giving good coverage with a coating depth of less than 1 mm and with some excess slurry pulled into the top end of the mold not used for the final sample. Separately, a foam solution was prepared by diluting Cedepal® FA406 (available from Stepan Chemicals) foaming agent with water to give a 0.5% solution by weight of foam concentrate. The required amount of diluted foam solution was placed in the cup of a Hamilton Beach Model 65250 mixer and the mixer run at high speed to prepare the foam solution. For the standard mix, two mixers were used, with 75 ml of diluted foam solution in each mixer for a total of 150 ml of diluted foam solution. In some cases the mix formulation required a different amount of foam solution, this being described in the description of each example. The foam mixers were started before the preparation of the stucco slurry and timed such that the foam would be mixed for about 1 minute before being used to prepare the board sample. At the required time, the foam was poured from the cups into the blender containing the gypsum slurry. Once the foam solution was added to the remainder of the stucco/water mix, the overall stucco/water/foam solution was mixed for a further 7 seconds on high speed once again. The foamed mix was then poured on top of the coated liner in the mold. The slurry was struck off with a straight edge held about 1 mm above the top of the mold, the top liner folded into place and then the liner pressed into place with two passes of a second straight edge. The overall mold was tilted at a slight angle to prevent the slurry from pouring from the mold in the event the slurry was particularly fluid.

If the bottom liner was not roller-coated, the stucco/accelerator blend was sifted into the water in a Cuisinart Model CB4J blender over 30 seconds, and the mixture was mixed on slow speed for 4 seconds. The foam solution that had been mixing was then added to the remainder of the stucco/water mix and the overall stucco/water/foam solution was mixed for a further 10 seconds on high speed once again. The foamed mixture was then poured on top of the bottom liner in the mold. The slurry was struck off with a straight edge held about 1 mm above the top of the mold, the top liner folded into place and then the liner pressed into place with two passes of a second straight edge. The overall mold was tilted at a slight angle to prevent the slurry from pouring from the mold in the event the slurry was particularly fluid.

After allowing the gypsum slurry to hydrate (about 20 minutes) the sample was carefully removed from the mold. The sample was trimmed to 8 inches by 9 inches, with the 8-inch dimension being in the MD or 14-inch liner dimension of the mold.

The remaining 8-inch by 9-inch sample was then dried as follows:

Normal driving process: The exposed core of the remaining 8 inch by 9 inch sample was covered by wrapping the edges with two thicknesses of 1 inch wide cotton adhesive tape. The sample was then dried in a convection oven at 475° F. until half of the free water was removed, and then the oven was reset to 225° F. until only 5-10 percent of the free moisture remained in the sample. After 90-95% of the free water was removed, the temperature was again reduced to 105° F. to finish drying the sample. Each sample was dried individually through the first two drying steps to ensure that the sample was dried in a consistent manner but was not over-dried.

Low Temperature Drying Process (for Low Melting Point Liners):

The exposed core of the remaining 8 inch by 9 inch sample was covered by wrapping the edges with two thicknesses of 1 inch wide cotton adhesive tape. The sample was then dried in a convection oven at 225° F. until half of the free water was removed, and then the oven was reset to 105° F. to finish drying the sample. Each sample was dried individually through the first drying step to ensure that the sample was dried in a consistent manner but was not over-dried.

After allowing the gypsum slurry to dry, a 1 inch strip of the board was carefully cut from the 8 inch by 9 inch sample leaving a 8 inch square sample.

The 8 inch square sample was cut in half to make two 4 inch by 8 inch samples for testing breaking strength as described below. It was possible to cut the sample either in the MD or the CD with reference to the sample preparation, but in all cases the sample was cut such that the long dimension of the sample was the MD of the sample preparation process.

Measuring the Breaking Characteristics of the Gypsum Board:

The gypsum board samples were 8 inches long and 4 inches wide and were broken over a 7 inch span on a Shimpo Model FGS-250 PVM programmable motorized test stand (manufactured by Nidec-Shimpo America Corporation, Itasca, Ill.). The board is set in the test stand with one side of the board facing downward in contact with the two supports over a 7 inch span, and the other side facing upward. The side of the board that faced downward during the board preparation as described above is also the downward-facing side of the board during the board-breaking. The upward-facing side of the board is impacted with the center load during the board-breaking. During the board-breaking, the downward-facing side of the board (side opposite to the center load) chiefly experiences tensile forces while the upward-facing side of the board in contact with the center load chiefly experiences compressive forces.

A 50 lb. force gauge (resolution 0.01 lb., accuracy 0.02% plus 1/2 digit at 73° F.) was used for bonding tests and a 500 lb. force gauge (resolution 0.1 lb., accuracy 0.02% plus ½ digit at 73° F.) was used for the breaking test measurements. The crosshead speed was 1.9 inches per minute with measurements taken every 0.2 seconds. Force in pounds vs. time in seconds was recorded at this constant crosshead speed to generate the stress-strain curve, also referred to as the breaking curve. The measurements were performed twice and the best value of the two breaking curves (force or load in pounds vs. deflection in inches) were reported as follows:

Initial Modulus (lb./in) was calculated as the initial slope of the force vs. deflection curve.

Yield Strength (lb.) was calculated as the force corresponding to a significant decrease in the initial slope of the breaking curve.

Strain (inches) is the deflection of the board as calculated by time multiplied by the speed of the crosshead as described above.

Peak Load (lb.) is the maximum force recorded during the breaking of the board.

Work-to-break (WTB) (lb.-in) is calculated as the area under the breaking curve up to a given deflection.

The wet adhesion strength between the liner and wet gypsum slurry during board forming was assessed as follows. Gypsum slurry of desired formulation was first prepared by mixing all ingredients in a Waring Blender for 10 seconds. The gypsum slurry was then poured in a 0.5″ tall mold with the liner at the bottom. The wet adhesion, or the adhesive bond, between the liner and the wet slurry was assessed by pulling the liner away from the core 20 minutes after mixing. The wet adhesion was graded as follows:
Very Good—The liner is intimately adhered to the gypsum core.
Good—The liner is adhered well to the gypsum core.
OK—The liner peels off with some effort.
OK/Poor—The liner peels off with ease.
Poor—The liner peels off without any effort.

Gypsum board was prepared for the Paintability Assessment as follows. A bottom liner 14 inches long and 12.4 inches wide was secured in a mold, which was 18 inches long and 10 inches wide and about 0.5 inch deep. Along each side of the long edge of the mold were spacers to provide a taper to the molded face of the sample, the spacers being 0.05 inch thick along each edge tapering down to 0.03 inch at 2 inches from each edge resulting in a board sample 0.5 inch thick over the center of the board up to a distance of 2.25 inches from each formed edge, and with a thickness of 0.47 inch at a distance of 2 inches from each edge and 0.045 inch along each edge. The bottom liner was creased and folded at a distance of 0.75 inch and 1.24 inches from each edge such that the liner laid across the bottom surface of the mold including the taper section, and was folded up the 0.5 inch sides to the mold and the remaining 0.75 inch wide flaps were folded out over the top of the sides to the mold. A piece of double sided adhesive tape was applied to the bottom side of these flaps such that when the slurry was poured into the mold and the edge flaps were folded over the slurry the adhesive tape made contact with the piece of liner used to make the back side of the board sample. The back liner was cut to dimensions of 14 inches long by 9.75 inches wide. Both liner pieces were held at one end in the mold, 0.5 inch apart through the use of a spacer. The mold was made such that the open end of the mold was 1 inch higher than the closed end of the mold, helping to keep the slurry from running out the open end of the mold. The top of the mold was open initially allowing the edge flaps of the bottom liner and the top liner to be folded in place once the slurry was poured on the bottom liner. The mold edges were 0.5 inch high such that when the slurry was poured on the bottom liner, the slurry was spread and the top liner put in place, a sample 10 inches wide, 0.5 inch thick and 12 inches long was prepared.

The board slurry was prepared as follows. The slurry formulation was 600 g stucco (CaSO4.1/2H2O), 1 g fine gypsum (CaSO4.2H2O), 130 g 4% Elvanol® 71-30 solution, 150 g 0.5% foaming agent Cedepal® FA406 solution and 245 g water.

The formulation was foamed using two Hamilton Beach model 65250 blenders (75 ml of solution in each blender) for about 60 seconds at high speed. While blending, the stucco/accelerator blend was sifted into the water in a Cuisinart Model CB-4J blender over 30 seconds, and the mixture was mixed on high speed for 7 seconds. At this point 50-75 ml of the mixture was quickly poured along one end of the mold on the back face of the bottom liner and a 10-inch wide trowel was used to spread the mix over the surface of the liner. Four passes of the trowel were made, giving good coverage with a coating depth of less than 1 mm and with some excess slurry pulled into the top end of the mold not used for the final sample. The foam solution that had been mixing was then added to the remainder of the stucco/water mix and the overall stucco/water/foam solution was mixed for a further 7 seconds on high speed once again. The foamed mixture was then poured on top of the coated liner in the mold. The slurry was struck off with a straight edge held about 1 mm above the top of the mold, the flaps of the bottom liner were folded over the slurry and the top liner folded into place and pressed onto the double sided adhesive strip with four passes of a second straight edge. As described above, the overall mold was tilted at a slight angle to prevent the slurry from pouring from the mold in the event the slurry was particularly fluid. After allowing the gypsum slurry to hydrate (about 20 minutes) the sample was carefully removed from the mold and was trimmed to 10 inches long by 10 inches wide. The exposed core of the remaining 10 inch by 10 inch sample was covered by wrapping the edges with two layers of 1 inch wide cotton adhesive tape. The sample was then dried in a convection oven at 475° F. until half of the free water was removed, and then the oven was reset to 225° F. until only 5-10 percent of the free moisture remained in the sample. After 90-95% of the free water was removed, the temperature was again reduced to 105° F. to finish drying the sample. Each sample was dried individually through the first two drying steps to ensure that the sample was dried in a consistent manner but was not over-dried.

Once dried the sample was cut down the middle of the board to allow each half of the board to be mounted tapered edge to tapered edge on a plywood substrate for finishing. The 10-inch long boards were mounted to 0.5-inch thick plywood using 2 drywall screws for each piece, the screws being spaced 6 inches from one another and 0.5 inch from the edge of the board. A commercially available joint cement from CGC Gypsum (Toronto, Canada), Ready to Use All Purpose Drywall Compound, was used with conventional paper drywall tape (CGC Gypsum Drywall Tape). The finishing technique used was the Level 4 finish technique as described in “Recommended Levels of Gypsum Board Finish” publication number GA-214-96 of the Gypsum Association, the trade association representing the gypsum industry in the U.S. and Canada. According to this technique, tape is embedded in joint compound with two separate coats of joint compound being applied after the first coat. The joint compound was allowed to dry, then coated with primer prior to painting with two coats of a flat paint finish. The surface was lightly sanded between each coat. Both latex- and oil-based primer/paint systems were evaluated (Glidden Maximum Hide Interior PVA Latex Primer 48180 White, Glidden Maximum Hide Interior Latex Flat 48100 White tinted to off-white, CIL Dulux Oil Based Primer Undercoat 1628 and CIL Dulux Super Alkyd Interior Paint Velvet Flat 3677 White tinted off-white).

Surface Indentation Resistance was measured as follows. A 4 inch by 4 inch gypsum wallboard sample was cut. The sample was placed on the support plate of a Gardner Impact Tester #IG 1120 (available from Paul N. Gardner Company, Inc., Pompano Beach, Fla.) with a 2 lb “striker,” with the face side of the board facing up under the striker. The support plate has a ring geometry that makes room for board material displacement on the back side of the board during impact. The striker is raised up the column of the impact tester to the 80 inch-lb mark (i.e., 40 inches up for a 2 lb weight) and is released, allowing it to fall and penetrate into the sample surface. The striker is then removed from the sample, and the sample removed from the support plate.

Using an ELE 0.01 mm resolution mechanical micrometer distance gauge (available from E L E International Ltd., Bedfordshire, England) mounted on a support stand, the gauge having a rounded measuring tip and an appropriate height base platform which is both solid and level, the height of the board in an unimpacted area (initial height) and at the lowest area in the center of the impact mark (final height) is measured. The surface indentation is calculated as the difference between the initial height and the final height, and is reported in inches

In all cases, the preparation and testing of the gypsum board samples was conducted to simulate the physical conditions of gypsum board made on a commercial production line, at critical junctures during the production process.

### EXAMPLES

In the following examples, the breaking characteristics are tested with the nonwoven liner on the side of the board opposite the side on which the center load is applied, such that the nonwoven liner experiences tensile forces during the board breaking.

The gypsum board strength properties are compared with standard paper-lined gypsum board from BPB Westroc (subsidiary of BPB plc, UK), commercially available glass fiber-lined Dens-Armor™ Plus from GP Gypsum (subsidiary of Georgia Pacific Corp., Atlanta, Ga.), fire resistant gypsum board (generally known as “Type X”) from BPB Westroc (subsidiary of BPB pic, U.K.) and abuse resistant/fire resistant gypsum board from CGC (a subsidiary of USG Corp., Chicago, Ill.). The gypsum board strength properties are also compared with a gypsum board lined on both sides with a polymeric nonwoven sheet material. Improvement over the prior art is also illustrated by comparing novel gypsum board per this invention with board made with flash-spun spun- bonded polyolefin product Tyvek® (available from DuPont) per the board making procedure given in Canadian Patent No.1,189,434.

Unless otherwise indicated, all the strength properties reported in following examples are for the MD of the board and liners.

### Comparative Example 1

A gypsum board product was made using a nonwoven sheet material as both the face liner and the back liner. The nonwoven sheet material was based on a mixture of monocomponent and bicomponent poly(ethylene terephthalate) (PET) fibers (available from E. I. du Pont de Nemours and Company (DuPont), Wilmington, Del.). The nonwoven sheet material contained 20% by weight bicomponent fibers having a PET sheath having a melting point of 180° C., and a high melting point PET core having a melting point of 250° C., with a remainder of monocomponent PET fibers. The bicomponent fibers were 3.0 denier per filament and had a cut length of 0.75 inch. The monocomponent PET fibers were 1.35 denier per filament and had a cut length of 0.85 inch. The fiber mixture was first carded and air-laid. The carded/air-laid web was then hydroentangled and dried. The material was then hot calendered to the thickness, bulk and pore size, as shown in Table 1. The strip tensile strength per unit basis weight in the MD and elongation under low load in both the MD and CD are shown in Table 2.

The liner of Example 1 was first tested for wet adhesion as follows. A gypsum slurry was first prepared by mixing the following ingredients in a Waring Blender for 10 seconds: 600 g stucco CaSO₄.1/2H₂O, 1 g fine gypsum CaSO₄2H₂O, 130 g of 4% Elvanol® 71-30, 500 g of water. The gypsum slurry was then poured in a 0.5″ tall mold with a nonwoven liner at the bottom. The wet adhesion, or the adhesive bond, between the liner and the wet slurry was assessed by pulling the liner away from the core 20 minutes after mixing the slurry as described in the Test Methods. The observed wet adhesion was graded OK. It is noted that the pressure involved during a commercial board-forming process would be much higher than the 0.5 inch head pressure of the slurry observed during this lab test and hence, it is anticipated that the wet adhesion obtained in a commercial process would be much higher.

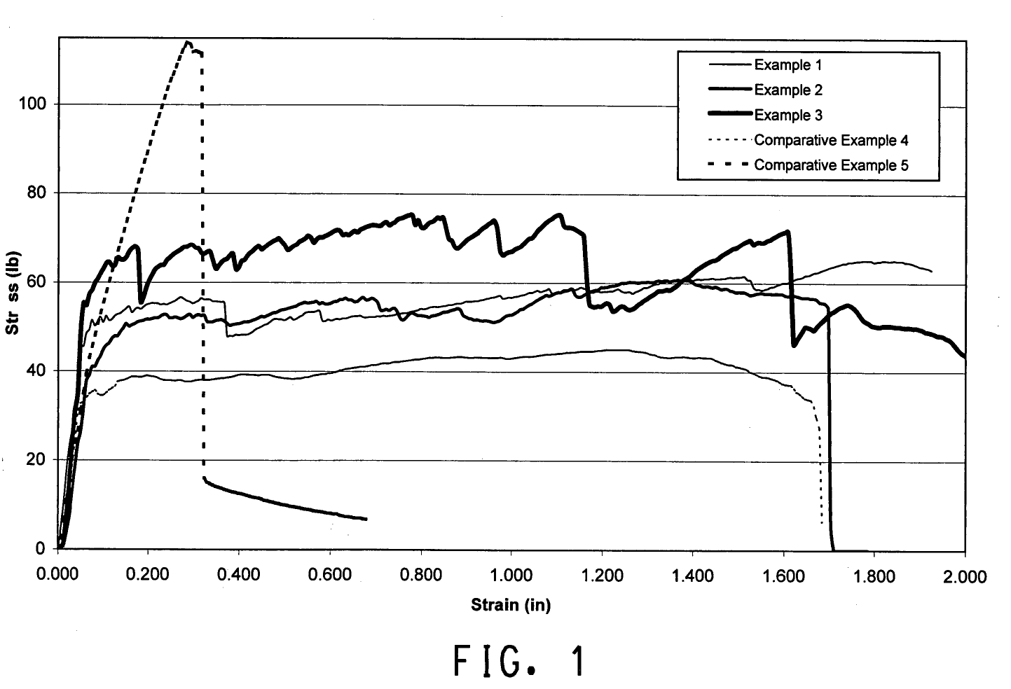

The gypsum test board was then prepared according to the procedure described in the Test Methods section. The gypsum slurry formulation for this example was as follows: 600 g Stucco (CaSO₄.1/2H₂O), 1 g fine gypsum (CaSO₄.2H₂O), 1 g K₂SO₄, 130 g of 4% Elvanol® 71-30 solution, 245 g of water and 150 ml of a 5% solution of Cedepal® FA406 foaming agent as described in the Test Methods. The liner of Example 1 was used on both sides of the test board. The dried board was then tested for strength according to the procedure described in the Test Methods section. The board breaking curve is given in FIG. 1 while the numeric values are given in Table 3.

### Inventive Example 2

The board of Example 2 was made according to Comparative Example 1 with the face liner being replaced by glass liner ELK K type, available from Elk Premium Building Products, Inc., Ennis Tex. The dried board was tested for strength according to the procedure described in the Test Methods section. It is noted that the nonwoven sheet material as described in Comparative Example 1 lined the side of the gypsum board opposite the side to which the center load was applied. In response to the force of the applied load, the nonwoven liner was under tension during the board breaking test. The glass-lined side of the gypsum board was in contact with the center load. The board breaking curve is given in FIG. 1 while the numeric values are given in Table 3.

### Inventive Example 3

The board of Example 3 was made according to Comparative Example 1 with the face liner being replaced by cellulosic paper. The dried board was tested for strength according to the procedure described in the Test Methods section. It is noted that the nonwoven sheet material as described in Comparative Example 1 lined the side of the gypsum board opposite the side to which the center load was applied. In response to the force of the applied load, the nonwoven liner was under tension during the board breaking test. The paper side of the gypsum board was in contact with the center load. The board breaking curve is given in FIG. 1 while the numeric values are given in Table 3.

### Comparative Example 4

The gypsum board of Comparative Example 4 was made according to Canadian Patent No.1,189,434; the liner was flash-spun spun-bonded polyolefin sheet, commercially known as Tyvek® 1085D, manufactured by DuPont. Thickness, bulk, pore size and other properties of the liner are given in Table 1. The core formulation was 600 g Stucco (CaSO₄.1/2H₂O), 0.433 g fine gypsum (CaSO₄.2H₂O), 4.35 g of starch (Fluidex® 50 from ADM, Montreal, Canada), 1.39 g of paper pulp, 0.31 g of Disal® powder dispersant (from Handy Chemicals, Candiac, Canada), 150 g of 0.5% foaming agent Cedepal® FA406 solution, 316 g of water. Comparative Example 4 was dried at 239° F. (116° C.) for one hour then at 103° F. (40° C.) overnight as described in Canadian Patent No. 1,189,434. As shown in Table 2, both MD and CD strength properties of Tyvek® 1085D are equivalent to MD strength properties of paper. However, as shown in Table 3, the modulus, peak load and WTB of the board made according to liner and core formulation as given in Canadian Patent No. 1,189,434 are quite low (Comparative Example 4). The board breaking curve is given in FIG. 1.

### Comparative Examples 5-7

Comparative Examples 5-7 are related to breaking properties of commercially available gypsum board products; Dens-Armor® Plus interior wallboard (available from Georgia-Pacific Corporation, Atlanta, Ga.) (Comparative Example 5), 0.5 in. thick, paper-lined regular gypsum board (Comparative Example 6) and Type X board (available from BPB Westroc, Mississauga, Canada) (Comparative Example 7). The breaking data for these commercially available products are given in Table 3. The board breaking curve for comparative Example 5 is given in FIG. 1

### Comparative Example 8

Comparative Example 8 was a commercially available fire resistant and abuse resistant gypsum board from CGC, a subsidiary of USG. This latter product is essentially a heavy weight, cellulosic paper-covered board with glass fibers in the core at a level that will give both abuse resistance and fire resistance properties.

TABLE 1

| | | | | | Mean | Mean | | Complete | |
|---|---|---|---|---|---|---|---|---|---|
| | Basis | | | | Flow | Flow | | seepage | |
| | Weight | Thickness | | Percent | Pore | Pore | | Of | Paper-like |
| | (BW) | (t) | | Void | Pressure | Diameter | Wet | gypsum | Smooth |
| Liner Material | oz/yd² | Mils | Bulk | % | psi | microns | Adhesion | slurry | surface |
| Nonwoven | 4.03 | 9.7 | 2.49 | 59.8 | 0.75 | 11.13 | Okay | No | Yes |
| Tyvek ® 1085D | 3.2 | 10.3 | 2.27 | 55.89 | 4.45 | 1.90 | Poor | No | No (shiny, smooth |
| | | | | | | | | | plastic film-like) |

TABLE 2

| | | | MD Strip Tensile Properties | | | | CD Strip Tensile Properties | | | | MD + CD |
|---|---|---|---|---|---|---|---|---|---|---|---|
| | | Thickness | | % Elong | % Elong | % Elong | | % Elong @ | % Elong @ | % Elong | TS per |
| Liner | BW | mils | TS | @ 1 lb | @ 3 lbs | @ break | TS | 1 lb | 3 lbs | @ break | BW |
| Nonwoven | 4.03 | 9.7 | 79.87 | 0.232 | 0.316 | 11.55 | 16.8 | 0.153 | 0.643 | 29.82 | 23.99 |
| ELK K | 2.36 | 20.0 | 25.53 | 0.165 | 0.264 | 1.417 | 23.99 | 0.068 | 0.188 | 1.48 | 20.98 |
| Glass | | | | | | | | | | | |
| Tyvek ® | 3.2 | 10.3 | 65.7 | 0.226 | 0.415 | 21.39 | 74.82 | 0.21 | 0.391 | 23.59 | 43.91 |
| 1085D | | | | | | | | | | | |
| Paper | 6.17 | 10.5 | 69.49 | 0.186 | 0.226 | 1.683 | 18.38 | 0.127 | 0.254 | 4.3 | 13.74 |

In Table 2, basis weight is designated as BW and expressed in oz/square yard; tensile strength is designated as TS and expressed in lb/in; percent elongation is designated as % Elong.

TABLE 3

| | | | | | Strain | | | | | | | |
|---|---|---|---|---|---|---|---|---|---|---|---|---|
| | | | | | at | | | | | | | |
| | | Yield | Yield | Peak | Peak | Work to Break (WTB) at: | | | | | | Board |
| | Modulus | Strength | Strain | Load (PL) | Load | PL | Yield. | 0.25″ | 0.5″ | 0.75″ | 1″ | weight |
| Example | lb/in | lb | in | lb | in | lb-in | lb-in | lb-in | lb-in | lb-in | lb-in | lb/msf |
| 1 (comparative) | 872 | 45.7 | 0.051 | 65.1 | 1.773 | 98 | 1 | 12 | 25 | 38 | 52 | 1657 |
| 2 | 760 | 37.8 | 0.063 | 60.8 | 1.386 | 72 | 1 | 10 | 23 | 37 | 50 | 1666 |
| 3 | 1230 | 55.4 | 0.057 | 75.4 | 1.102 | 73 | 1 | 13 | 30 | 48 | 66 | 1789 |
| 4 (comparative) | 480 | 32 | 0.051 | 45 | 1.21 | 1.4 | 0.8 | 8.0 | 17.8 | 27.8 | 38.6 | 2032 |
| 5 (comparative) | 617 | 114 | 0.285 | 114.2 | 0.285 | 19.0 | 19.0 | 15.0 | 25.0 | 27.0 | 27.0 | 2165 |
| 6 (comparative) | 700 | 85 | 0.133 | 90.9 | 0.196 | 11.6 | 7.2 | 16.0 | 20.6 | 20.6 | 20.6 | 1625 |
| 7 (comparative) | 974 | 78 | 0.095 | 102 | 0.171 | 11.2 | 3.4 | 13.4 | 16.4 | 17.0 | 17.0 | 1716 |
| 8 (comparative) | 1314 | 72 | 0.063 | 111 | 0.139 | 18.8 | 2.2 | 13.6 | 17.4 | 19 | 19.8 | 2340 |

### Indentation R sistanc

The bottom side of the test board of Comparative Example 1 and Examples 2-3 lined with the nonwoven liner was tested for surface indentation resistance according to the procedure described in the Test Methods section. The nonwoven lined side of the gypsum board (the side facing downward during the board-making process) was exposed to 80 in-lbs impact load. The indentation data are as follows.

| Example | Indentation |
|---|---|
| 1 (comparative) | 0.34 inch |
| 2 | 0.37 inch |
| 3 | 0.33 inch |

### Paintability Assessment

The board of Comparative Example 1 was tested for gypsum board finish level according to the procedure described in the Test Methods section.

A gypsum board similar to Comparative Example 1 was made using the alternative nonwoven liner described below.

The base substrate (uncalendered) for the alternative nonwoven liner was provided by the Polymer Group, Inc. (PGI) of North Charleston, S.C. The nonwoven liner material was based on a mixture of standard and bicomponent PET fibers. The nonwoven sheet material contained 15% by weight bicomponent fibers having a low melting PET sheath (melting point of 180° C.) with a high melting point PET core (melting point of 250° C.), with a remainder of standard (monocomponent) PET fibers. The denier of bicomponent fibers was 3 and that of standard PET fibers was 1.2. The fiber mixture was first carded and air-laid. The carded/air laid web was then hydroentangled and dried. The material was then hot calendered to the desired thickness, bulk and pore size. The nonwoven liner material had a basis weight of 3.7 oz/yd², a thickness of 8.6 mils, a bulk of 2.4 t.BW*density, a percent void of 58%, a mean flow pore pressure of 0.83 psi and a mean flow pore diameter of 10.2 microns.

The material had a smooth, paper-like surface. Both boards were painted and visually inspected. The painted boards, having joints in the middle, had a uniform look similar to conventional paper-lined gypsum wallboard over the entire board surface, including the joints, so that the joints were not visible.

1. A gypsum board comprising a gypsum core held between two sheets of liner wherein one sheet is a face liner for covering the exposed side of the gypsum board and the other sheet is a back liner for covering the non-exposed side of the gypsum board wherein one of the liners is a polymeric nonwoven sheet material, and wherein the work-to-break of the gypsum board in the MD of the polymeric nonwoven sheet material at a strain of 0.75 inch is greater than 30 lb-in when the work-to-break test is conducted with the center load applied to the board on the side opposite the polymeric nonwoven sheet material.

2. The gypsum board of claim 1 wherein the polymeric nonwoven sheet material is the face liner.

3. The gypsum board of claim 1 wherein the polymeric nonwoven sheet material is the back liner.

4. The gypsum board of claim 1 wherein on the side opposite the polymeric nonwoven sheet material, the liner comprises at least one sheet comprising glass fibers.

5. The gypsum board of claim 1 or 4 wherein the gypsum core is free of nutrients capable of supporting microbial growth.

6. The gypsum board of claim 5 wherein the gypsum board is free of nutrients capable of supporting microbial growth.

7. The gypsum board of claim 1 wherein on the side opposite the polymeric nonwoven sheet material, the liner comprises at least one sheet of paper.

8. The gypsum board of claim 1 wherein on the side opposite the polymeric nonwoven sheet material, the liner comprises a woven fabric, a film and/or a scrim.

9. The gypsum board of claim 2, wherein the face liner has a surface finish without the need for surface treatment over a significant portion of the surface of the polymeric nonwoven sheet material.

10. The gypsum board of claim 2 wherein the board has an indentation resistance on the face side of the gypsum board of at least 0.4 inch.

11. A gypsum board comprising a gypsum core held between two sheets of liner wherein one sheet is a face liner for covering the exposed side of the gypsum board and the other sheet is a back liner for covering the non-exposed side of the gypsum board wherein one of the liners is a polymeric nonwoven sheet material, and wherein the work-to-break of the board in the MD at a strain of 0.75 inch is greater than 60*X lb.-in. where X is the thickness of the board in inches, when the work-to-break test is conducted with the center load applied to the board on the side opposite the polymeric nonwoven sheet material.

12. The gypsum board of claim 1 or 11 wherein the gypsum board has a thickness in the range of about 0.125 to about 2 inches.

13. The gypsum board of claim 1 wherein the work-to-break in the CD at a strain of 0.75 in is greater than 10 lb-in.

14. The gypsum board of claim 1 wherein the polymeric nonwoven sheet material comprises a polymer having a softening or melting point of at least 150° C.

15. The gypsum board of claim 1 wherein the two sheets of liner form an envelope to hold the gypsum core, each of the two sheets having a first and a second edge, and wherein the first edge of one sheet is joined to the first edge of the other sheet and the second edge of each sheet is joined to the second edge of the other sheet.

16. The gypsum board of claim 15 wherein an adhesive is used to join the edges of the two sheets.

17. The gypsum board of claim 1 wherein the board has a MD initial modulus of at least 500 lb/in.

18. The gypsum board of claim 1 wherein the board has a MD peak load of at least 40 lb.

19. The gypsum board of claim 1 wherein the board has a MD work-to-break at peak load of at least 30 lb-in.

20. The gypsum board of claim 1 wherein the board has a MD peak load of at least 40 lb and a work-to-break at peak load of at least 30 lb-in.

21. The gypsum board of claim 1 wherein the board has a bending strain of greater than 0.5 inches at a bending stress of greater than 40 lb. without breaking the nonwoven sheet.

22. The gypsum board of claim 1 wherein the board has a bending strain of greater than 1 inch at a bending stress of greater than 45 lb. without breaking the nonwoven sheet.

23. The gypsum board of claim 1 wherein the board has a loss in MD flexural strength of less than 75% when flexural strength peak load is measured immediately after holding the board under water for 2 hours as per ASTM C36.

24. The gypsum board of claim 1 wherein the polymeric nonwoven sheet material has a strip tensile strength in the MD of at least 35 lb./in.

25. The gypsum board of claim 1 wherein the polymeric nonwoven sheet material has a strip tensile strength in the CD of at least 12 lb./in.

26. The gypsum board of claim 1 wherein the polymeric nonwoven sheet material has a percent elongation in the MD of less than 0.7% at 1 pound of force.

27. The gypsum board of claim 1 wherein the polymeric nonwoven sheet material has a percent elongation in the MD of less than 1.5% at 3 pounds of force.

28. The gypsum board of claim 1 wherein the polymeric nonwoven sheet material has a percent elongation at break in the MD of less than 100%.

29. The gypsum board of claim 1 wherein the polymeric nonwoven sheet material has a percent elongation in the CD of less than 3.0% at 1 pound of force.

30. The gypsum board of claim 1 wherein the polymeric nonwoven sheet material has a percent elongation in the CD of less than 7.0% at 3 pounds of force.

31. The gypsum board of claim 1 wherein the polymeric nonwoven sheet material has a percent elongation at break in the CD of less than 300%.

32. The gypsum board of claim 1 wherein the polymeric nonwoven sheet material has a mean flow pore diameter of 5-100 micrometers, a mean flow pore pressure of less than 3 psi and a bulk of greater than 1.25.

33. The gypsum board of claim 1 wherein the polymeric nonwoven sheet material has mean flow pore diameter of 7-70 micrometers, a mean flow pore pressure of less than 1 psi and bulk of greater than 2.

34. The gypsum board of claim 1 wherein the polymeric nonwoven sheet material has sufficient stiffness to render it scorable and/or foldable.

35. The gypsum board of claim 2 wherein the exposed surface of the polymeric nonwoven sheet material has a smoother surface than the unexposed surface in contact with the gypsum core.

36. The gypsum board of claim 1 wherein at least one of the sheets of liner has an embossed pattern thereon.

37. The gypsum board of claim 1 wherein the polymeric nonwoven sheet material comprises a mixture of monocomponent fibers and bicomponent fibers, wherein the bicomponent fibers comprise a sheath and a core, and wherein the softening or melting point of the sheath is sufficiently lower than the softening or melting point of the core and the softening or melting point of the monocomponent fibers.

38. The gypsum board of claim 37 wherein the polymeric nonwoven sheet material further comprises 15-35% by weight bicomponent fibers.

39. The gypsum board of claim 1 wherein the polymeric nonwoven sheet material is a composite structure consisting of nonwoven sheet combined with woven fabric, film, foil and/or scrim.

40. The gypsum board of claim 1 wherein the polymeric nonwoven sheet material further comprises an antimicrobial agent.

41. The gypsum board of claim 1 wherein the gypsum core comprises gypsum and polymeric binder.

42. The gypsum board of claim 41 wherein the gypsum core further comprises set accelerator, foaming agent, polyvinyl alcohol binder, water reducing agent, ground gypsum accelerator, potassium sulfate, set retarder, water-proofing agent, anti-burning agent, anti-microbial agent, or combinations thereof.

43. The gypsum board of claim 42 wherein the gypsum core further comprises glass fibers.

44. The gypsum board of claim 1 wherein the ratio of the flexural strength peak load in the MD to the peak load in the CD is less than 3.

45. The gypsum board of claim 1 or 11 wherein the board has a bending strain of greater than 1 inch without breaking the sheets of the liner.

46. The gypsum board of claim 44 wherein the thickness of the board is at least 0.125 in.

47. A gypsum board comprising a gypsum core held between two sheets of liner wherein one sheet is a face liner for covering the exposed side of the gypsum board and the other sheet is a back liner for covering the non-exposed side of the gypsum board wherein one of the liners is a polymeric nonwoven sheet material, and wherein the polymeric nonwoven sheet material has strip tensile in the MD of at least 35 lb./in., percent elongation at 1 lb. in the MD of less than 0.7%, percent elongation at 3 lb. in the MD of less than 1.5% and percent elongation-at-break in the MD of less than 100%, strip tensile in the CD of at least 12 lb./in., percent elongation at 1 lb. in the CD of less than 3.0%, percent elongation at 3 lb. in the CD of less than 7.0% and percent elongation-at-break in the CD of less than 300%.

48. The gypsum board of claim 47 wherein the polymeric nonwoven sheet material has a mean flow pore diameter of 5-100 micrometers, a mean flow pore pressure of less than 3 psi and a bulk of greater than 1.25.

49. The gypsum board of claim 47 wherein the polymeric nonwoven sheet material has mean flow pore diameter of 7-70 micrometers, a mean flow pore pressure of less than 1 psi and bulk of greater than 2.

50. The gypsum board of claim 47, wherein the polymeric nonwoven sheet material has strip tensile in the MD of at least 65 lb./in., percent elongation at 1 lb. in the MD of less than 0.5%, percent elongation at 3 lb. in the MD of less than 0.7% and percent elongation-at-break in the MD of less than 50%, strip tensile in the CD of at least 22 lb./in., percent elongation at 1 lb. in the CD of less than 1.5%, percent elongation at 3 lb. in the CD of less than 3.0% and percent elongation-at-break in the CD of less than 100%.
